(19) United States
(12) Patent Application Publication
(10) Pub. No.: US 2022/0309591 A1
(43) Pub. Date: Sep. 29, 2022

(54) SYSTEM AND METHOD OF DETERMINING AND PROVIDING BINDABLE INSURANCE QUOTES

(71) Applicant: Frontline Insurance Managers Inc., Lake Mary, FL (US)

(72) Inventors: West McCall, Lake Mary, FL (US); Alvaro Ortiz, Lake Mary, FL (US); Charles Gould, Lake Mary, FL (US); Leman Porter, Lake Mary, FL (US)

(73) Assignee: Frontline Insurance Managers Inc., Lake Mary, FL (US)

(21) Appl. No.: 17/703,529

(22) Filed: Mar. 24, 2022

Related U.S. Application Data
(60) Provisional application No. 63/165,336, filed on Mar. 24, 2021.

(51) Int. Cl. G06Q 40/08

(52) U.S. Cl. CPC G06Q 40/08

(57) ABSTRACT

Systems and methods are disclosed herein for accessing and extracting data from several sources and analyzing rate data to perform underwriting and de-risking calculations to generate bindable insurance quotes. The method includes receiving a property address from a user. The system may be configured to receive data relating to the property and person seeking insurance coverage through third-party or internal data sources. The system may then be configured to receive property data and demographic data from one or more data sources, normalize and parse the data, analyze the data based on a set of underwriting rules, rating rules, and de-risking rules, and determine an insurance premium quote that is bindable without having an agent involved at all.

### REFERENCE TO RELATED APPLICATIONS

This application claims the benefit of U.S. Provisional Patent App. No. 63/165,336 filed on Mar. 24, 2021, titled System and Method of Determining and Providing Bindable Insurance Quotes, the disclosure of which is herein incorporated by reference.

### FIELD

The present disclosure relates generally to the insurance industry and particularly relates to a system and methods for automatically gathering, underwriting, and de-risking data pertaining to an online user to generate a bindable insurance quote, thereby reducing the need for human review by the insurance provider of policy proposals.

### BACKGROUND

The process of obtaining insurance on property through an online application typically requires a potential customer to provide 30 to 40 pieces of information about the property and the customer. However, information about the property may not be readily known by a customer and must be acquired by looking to other sources. Even after acquiring customer and property information, the information must be validated by the company. Whether the information is provided in-person, on paper, or online, the back and forth with the agent can take days or even weeks for a customer to finally be provided with a bindable proposal.

The process of obtaining insurance on property through an online application platform requires a potential customer to provide information about the customer and the home. Typically, a potential customer must provide thirty to forty items of information in the online application or in follow-up discussions with an agent. For example, an application for insurance on a home requires the address of the home, the roof and wall materials, the type of roof, when the roof was last replaced, square footage, when the home was built, if the home is in a flood zone, proximity to a fire station, and the like. Once the application has been completed, the company must validate the information, which may be done by looking to other information sources. Even after the information is validated, an insurance company must consider many factors to determine an appropriate premium for a policy. Generally, whether this process is performed in person, on paper, or online, the back and forth with the agent required to validate the information may take several days or even weeks. Thus, there is a need for an insurance platform that acquires and validates information with minimal input from a customer, and analyzes the information to provide an underwritten, bindable insurance policy proposal to an online user in a matter of minutes.

### SUMMARY

The systems and methods described herein address the afore-mentioned needs in the art by providing an electronic communications platform that receives property and personal information about home insurance applications from either an individual or prospective customer or through various data sources for expedited completion and approval of insurance applications. The insurance application information is obtained from one or more relevant information sources and then normalized and mapped to a template in a standard format for obtaining a quote based on the acquired information. Logic and business rules are used to enable real-time determinations of underwriting and de-risking decisions that are typically made by or reviewed by underwriters after an online application has been submitted.

In some embodiments, a method for performing an insurance process includes: receiving, by one or more processors, search data relating to a property seeking insurance coverage; querying by a communications device an interface of a third-party platform based on the search data; receiving, by the one or more processors, insurance application data from the third-party platform; analyzing, by the one or more processors, the insurance application data to determine a premium quote.

In some embodiments, a system for making an insurance evaluation includes a memory, coupled to one or more computer processors, storing program instructions which may include underwriting rules, rating rules, and de-risking rules. The process identifies and customizes coverage protection designed for the customer by combining probability and severity of loss potential, using risk characteristics.

In some embodiments, a method for determining a rating and score for the customer is performed without agent assistance relying entirely on a computer system for gathering information on an entity and determining an insurance premium price for the entity. The method begins with obtaining a property address. The method does not require any personally identifying information from a potential customer until after a bindable quote has been presented. Once the address is obtained, the method includes obtaining data related to the property from one or more data sources. The one or more data sources may be queried simultaneously or in a predetermined sequence based on preset rules. Once it has been determined that no more additional data is needed, computerized predictive models and/or other processing elements analyze information related to the entity, and an insurance price is presented. Finally, the insurance at the determined premium price is offered to the entity.

In another exemplary embodiment, a method for processing data related to at least one quote for a property insurance product, comprises: accessing, by at least one processor, data stored in a memory, the data comprising data relating to a plurality of insurance processes related to the at least one insurance product, the plurality of insurance processes comprising a process for determining insurance application information relating to a prospective customer, a process for underwriting, a process for determining a risk category, and a process for determining at least one insurance quote; providing, by the at least one processor, a graphical user interface for display, configured for entry of a property address; receiving, by the at least one processor, information entered via the graphical user interface; requesting, by the at least one processor, insurance application information from one or more data sources; receiving, by the at least one processor, the insurance application information from the one or more data sources; retrieving, from a memory, proprietary data; applying, by the at least one processor, underwriting rules to the insurance application information and the proprietary data; determining, by the at least one processor, a risk category based the insurance application information and proprietary data; responsive to a determination of an acceptable risk category, generating an initial insurance quote of the property insurance product for a prospective customer; providing, by at least one processor, a coverage and rewards adjustment interface to the prospective customer; receiving a customized rewards selection and a set of customized coverage parameters from the prospective customer; requesting, by at least one processor, from one or more data sources additional information about the prospective customer; and generating, by at least one processor, a final quote for the property insurance product.

In one exemplary embodiment, the risk category is selected from the group consisting of green, yellow, or red. After determining the risk category, the system may flag the application as ineligible and send it to an offline agent for further processing.

In some embodiments, after generating a final quote, responsive to a determination of a risk category of green, the system may request billing information to bind a policy for the property insurance product; and request a self-inspection by the prospective customer.

In some embodiments, after generating a final quote, responsive to a determination of a risk category of yellow, the system may request a self-inspection by the prospective customer, then request billing information and binding a policy for the property insurance product.

In one exemplary embodiment, a system for making an insurance evaluation related to property insurance, the system comprising: one or more data sources storing data relating to insurance coverage and insurance risk; one or more computer processors in communication with the one or more data sources; a virtual server in communication with the one or more data sources; a communications device in communication with the virtual server; and a memory, in communication with the one or more computer processors, storing program instructions. The memory cause the one or more computer processors to: provide a platform that is configured to be accessed by a prospective customer over an internet network; receive a property address of the prospective customer; request insurance application data from one or more data sources; receive insurance application data from the one or more data sources; analyze the insurance application data with underwriting rules implemented by the platform; determine a risk category for the prospective customer; generate an initial quote for an insurance product; receive, from the prospective customer, customized coverage parameters and customized rewards options; request loss history information and insurance rating information from one or more data sources; and generate a final quote for the insurance product.

In another exemplary embodiment, a method of providing one or more bindable insurance quotes to a prospective customer without receiving any personally identifying information from the prospective customer, the method comprising: providing, by a system having at least one processor and at least one memory, a first graphical user interface configured for entry of a property address; receiving the property address from the prospective customer; requesting, from one or more data sources, insurance application information about the property address; receiving the insurance application information from the one or more data sources; applying underwriting rules stored on the memory to the insurance data; determining a risk category; determining an initial quote based on one or more underwriting rules and risk category; providing a second graphical user interface configured for customizing insurance coverage parameters and reward options; determining a finalized quote; providing a third graphical user interface configured for entry of personal information from the prospective customer; and generating disclosure schedules for the finalized quote.

In some embodiments, the method further comprises, after providing a second graphical user interface: requesting, from one or more data sources, a loss history and an insurance rating for the prospective customer.

### DESCRIPTION OF THE FIGURES

FIG. 1 is a block diagram of a system according to the present disclosure.

FIG. 2 is a flow chart illustrating the method of providing a bindable insurance quote according to the present disclosure

FIG. 3 is a block diagram illustrating a second embodiment of a system implementing the method of the present disclosure.

### DETAILED DESCRIPTION OF EXEMPLARY EMBODIMENTS

In the figures, the circuits and associated blocks and arrows represent functions of the processes according to the present disclosure, which may be implemented as electrical circuits and associated wires or data busses, which transport electrical signals. Alternatively, one or more associated arrows may represent communication (e.g., data flow) between software routines, particularly when the present method or apparatus of the present invention is a digital process.

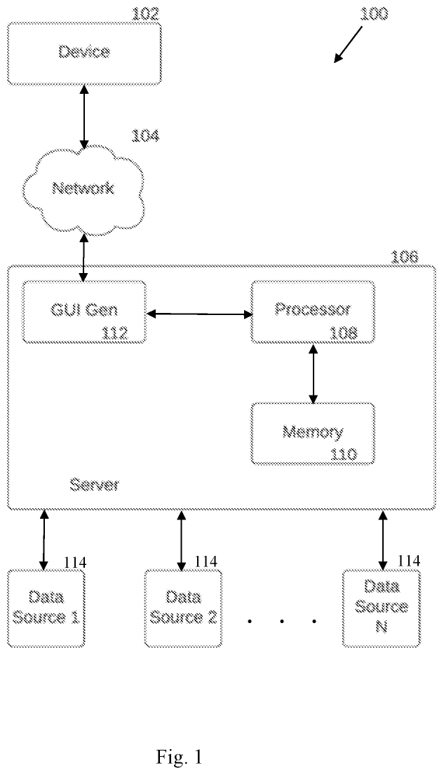

Referring to FIG. 1, an electronic communications platform used to implement the method of providing one or more bindable insurance quotes is shown. As illustrated in FIG. 1, the platform 100 is set up in a client server arrangement where prospective customers use personal devices 102 and network 104 to communicate with a virtual server 106. The personal device 102 may be a desktop computer, laptop, mobile phone, tablet, or other suitable electronic communication device. The network 104 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a Wi-Fi network, a WiMAX network, another type of network, or a combination of two or more such networks.

The virtual server 106 includes one or more processors 108 for executing instructions provided by one or more memories 110 for implementing the processes described herein. The virtual server 106 also includes a graphical user interface (GUI) generator 112 controlled by the processor(s) 108 to generate GUIs for sending data over the network 104 to the devices 102. As explained in more detail below, the processor(s) 108 implement processes for obtaining information from one or more data sources 114. As the information is obtained, the server 106 may include instructions to pre-fill an insurance application.

In one embodiment, the memory 110 may include legacy processes or a legacy database with aggregated insurance application information. In some embodiments, the one or more processors 108 receive the insurance application information from a combination of the memory 110 and the one or more data sources 114.

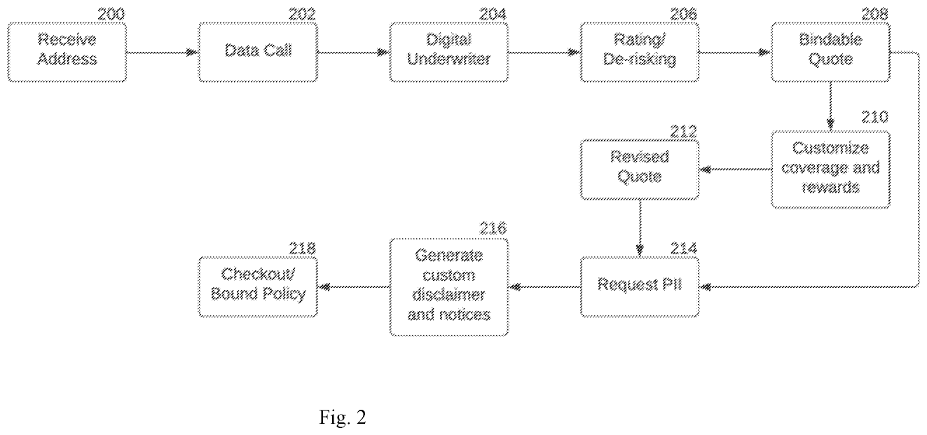

Referring to FIG. 2, a flow chart illustrating a method of providing one or more bindable insurance quotes without requiring any personally identifiable information is shown. First, a property address is received at 200. The address may be input by a prospective customer on a website from his or her personal device. Once the address is received, a data call is performed at 202. The data call 202 may request information from one or more sources 114. The data source 114 may be publicly available information sources, geospatial data sources, government entities, information vendors, or internal information sources. Data acquired may include location, dwelling type, age of home, construction type, age of roof, roof shape, roof material, roof condition, ownership data, parcel data, property transaction history, business pursuits, pool presence, pool condition, yard debris, tree occlusion or proximity, nuisances, presence of solar panels, and the like.

Once the data is received, a digital underwriting application run by the server 106 is performed at 204. The digital underwriting rules which may be stored in the memory 110 may determine if the address is eligible for coverage by analyzing the zip code acquired in the data call with a preset rule for acceptable geographic range. The digital underwriter may also verify location and property type by parsing and normalizing data received by the data sources 114. In one embodiment of the present method, the underwriting rules may be set to select for only single family homes located in a specific geographic region.

In addition to underwriting rules implemented by the server 106, the server 106 also implements rating/de-risking rules at 206. The rating/de-risking rules 206 may be implemented by the server 106 at the same time as the digital underwriting 204. The rating/de-risking at 206 analyzes data acquired in either the first data call 200, or a subsequent data call, to determine an insurance score. A unique insurance score is generated for each prospective customer. The server 106 implementing the method of providing one or more bindable insurance quotes incorporates the insurance score into its process of calculating the bindable quote.

The process provides a prospective customer with insurance options with an appropriate level of coverage for the prospective customer. The process determines probability and severity of loss potential based on risk characteristics.

By way of example, an underwriting rule may decline to cover homes built prior to 1980. The one or more data sources may return differing dates for year built information. For example, the processor 108 may receive information about age of the home from five data sources. The results may be: data source 1 says 1979, data source 2 says 1980, data source 3 says 1981, data source 4 says 1980, and data source 5 says 1980. The processor 108 normalizes and parses the information and selects 1980 as the year built. The processor 108 then runs the de-risking rules before determining the quote. The de-risking rules are configured to adjust coverage limits or deductibles for various types of coverage such as water damage, additional structures, wind deductible, and the like. Based on the de-risking rules stored in the memory 110, the processor 108 adjusts the coverage that will be offered and determines the premium quote that will be presented to the customer.

After underwriting and rating, a bindable quote is generated at 208. The bindable quote 208 was generated without the need for a prospective customer to provide any personally identifying information (PII). All that was required was a property address. The server 106 using data from various sources allows the insurance company to calculate a policy quote with enough certainty to offer a bindable quote to a customer without the need to acquire any PII.

After the bindable quote is generated at 208, the customer may proceed to providing PII at 214 (arrow A) or proceed to a customizable rewards step at 210 (arrow B). Alternatively, the system may require the customer to first address customizable rewards, then customize coverages, and then provide PII.

Alternatively, if the customer opts to customize coverage and rewards at step 210, the customer may adjust coverages or select rewards options that will adjust the bindable quote. The system 106 is configured to generate an interactive web page that allows a user to adjust every coverage and deductible in the policy. The customer may increase or decrease coverages or add optional coverages such as optional Additional 25% toward home rebuilding cost, separate structures, coverage for belongings, additional valuable items, protection for backed up water, sudden and accidental loss due to water, ordinance protection, screened enclosure coverage for hurricane, golf cart coverage for damage and liability, slander and libel protection, animal liability coverage, home owners' association (HOA) assessment coverage. The customer may also obtain rate decreases for certain rewards options such as being a pet owner, fire alarm system, burglar alarm, video door bell, high air conditioning SEER rating, fire extinguisher, smart locks, solar panels, pest control services, home warranty, whole home generator, member of an HOA, safe driver, purchased life insurance, identity theft protection, organ donor, smart thermostat, blood donor, gym membership, or smart devices.

The bindable quote at 208 is presented in a graphical user interface or a browser to the customer which is in communication with the server 106 such that each adjustment of coverage or selection of a reward adjusts the quote in real time. After the customer has completed the customization at step 210, a revised quote is presented to the customer at step 212.

This revised insurance premium quote is bindable, just as the initial insurance premium quote, without ever having requested PII from the customer.

In some embodiments, when the customer elects to complete the process and bind the quote, the system 106 is configured to require input of PII in response to the customer selecting to bind the quote.

In some embodiments, the system 106 is configured to generate customized legal disclosures at 216 based on the customer's modification of coverages in 210. For example, if a customer elects to forego coverage for water damage, the system 106 is configured to generate a legal disclosure regarding water damage coverage based on relevant laws or regulations on the same page as the PII. The customer cannot finalize purchase of the policy without reading and accepting all relevant legal disclaimers.

In the final step 218, the customer is able to finalize purchase of the insurance policy through the system 106 without ever having dealt with an underwriting agent.

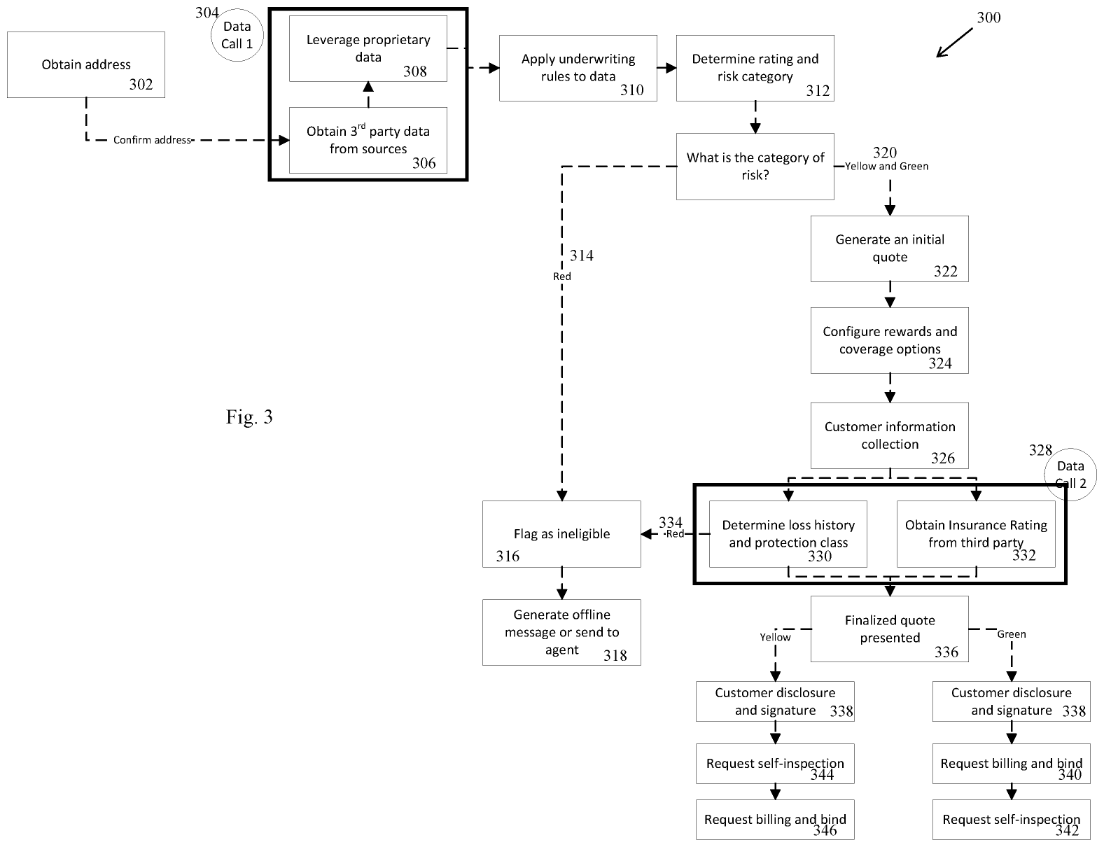

Referring now to FIG. 3, a block diagram illustrating a second embodiment of a system implementing the method of the present disclosure is shown. In this exemplary embodiment, a prospective customer is prompted by the user interface to input a property address to be insured 302. In some embodiments, the property address must be a residential property address. After the property address is received by the system 300, a first data call 304 is performed to acquire information from third party sources 306. The system 300 then uses proprietary data 308. In some embodiments, the proprietary date 308 includes a replacement cost estimator. The replacement cost estimator may predict coverage based on home value distribution by zip code. By way of example, characteristics that are relevant are construction type, square footage, solar panels, pool, or other unique home features. In some embodiments, proprietary data 308 includes wind mitigation. Wind mitigation may be based on age and location of the home.

Next, underwriting rules stored in the memory are used to analyze the data acquired 310. After underwriting analysis, a risk category is then determined for the prospective customer's application 312. In some embodiments, the risk categories are green, yellow, and red. The determination of category is done by underwriting logic rules, stored in the memory, and applied by a processor that interpret risk attributes to assign a level of risk to determine eligibility. In embodiments with a green, yellow, red scale, green is good, yellow is intermediate, and red would be the lowest rating and ineligible.

If the risk category is determined to be red 314, the application is flagged as ineligible 316. In some embodiments, the system may then send an offline message to the prospective customer or send the application to an agent for manual processing 318.

If the risk category is determined to be green or yellow 320, the system 300 will generate an initial quote 322. The prospective customer is then prompted by the system 300 to configure rewards and coverage options 324. In some embodiments, this is done by the system 300 presenting a user interface to the customer to customize reward options and coverage parameters. After coverages and rewards are customized, customer information is collected to build out the application for the property insurance product 326.

In some embodiments, the customer information is collected in a second data call 328 to third party data sources. In the second data call 328, loss history and protection class may be acquired 330. In the second data call 328, an insurance rating may also be acquired 332. If the loss history, protection class, or the insurance rating are determined to be poor, the system 300 will recategorize the prospective customer into a yellow or red category 334.

At this point, a final quote is presented for the property insurance product 336 and customer disclosures are generated and a digital signature is obtained 338. If the prospective customer's risk category is green, the system 300 requests billing information and binds the policy 340. The now customer is then required to perform a self-inspection to complete the file 342.

If the risk category for the prospective customer is yellow, the system 300 will first request the self-inspection 344 before the policy can be bound. Once the prospective customer submits the self-inspection, the system 300 requests billing information and binds the policy 346.

Although the inventive concepts of the present disclosure have been described and illustrated with respect to exemplary embodiments thereof, it is not limited to the exemplary embodiments disclosed herein and modifications may be made therein without departing from the scope of the inventive concepts.

The methods described herein may be executed by one or more computer processors in communication with one or more data storage devices, display devices, user input devices, communication devices and other hardware devices. Such hardware devices may be co-located or location at more than physical location. In embodiments, cloud-based computing techniques, in which processing, communication and/or data storage are performed by use of third-party processing, communication and/or data storage resources of third parties may be employed for one or more steps in the processes described herein.

Variations, modifications, and other implementations of what is described may be employed without departing from the spirit and scope of the disclosure. More specifically, any of the method and system features described above or incorporated by reference may be combined with any other suitable method, system, or device feature disclosed herein or incorporated by reference, and is within the scope of the contemplated systems and methods described herein. The systems and methods may be embodied in other specific forms without departing from the spirit or essential characteristics thereof. The foregoing embodiments are therefore to be considered in all respects illustrative, rather than limiting of the systems and methods described herein.

What is claim is:

1. A method for processing data related to at least one quote for a property insurance product, comprising:
accessing, by at least one processor, data stored in a memory, the data comprising data relating to a plurality of insurance processes related to the at least one insurance product, the plurality of insurance processes comprising a process for determining insurance application information relating to a prospective customer, a process for underwriting, a process for determining a risk category, and a process for determining at least one insurance quote;
providing, by the at least one processor, a graphical user interface for display, configured for entry of a property address;
receiving, by the at least one processor, information entered via the graphical user interface;
requesting, by the at least one processor, insurance application information from one or more data sources;
receiving, by the at least one processor, the insurance application information from the one or more data sources;
retrieving, from a memory, proprietary data;
applying, by the at least one processor, underwriting rules to the insurance application information and the proprietary data;
determining, by the at least one processor, a risk category based the insurance application information and proprietary data;
responsive to a determination of an acceptable risk category, generating an initial insurance quote of the property insurance product for a prospective customer;
providing, by at least one processor, a coverage and rewards adjustment interface to the prospective customer;
receiving a customized rewards selection and a set of customized coverage parameters from the prospective customer;
requesting, by at least one processor, from one or more data sources additional information about the prospective customer; and
generating, by at least one processor, a final quote for the property insurance product.

2. The method of claim 1, wherein the information entered via the graphical user interface is a residential property address.

3. The method of claim 1, wherein the risk category is selected from the group consisting of green, yellow, or red.

4. The method of claim 3, further comprising, after the step of determining the risk category, responsive to a determination of a risk category of red, flagging the application as ineligible and sending to an offline agent for further processing.

5. The method of claim 3, further comprising:
after the step of generating a final quote, responsive to a determination of a risk category of green, requesting billing information and binding a policy for the property insurance product; and
requesting a self-inspection by the prospective customer.

6. The method of claim 3, further comprising:
after the step of generating a final quote, responsive to a determination of a risk category of yellow, requesting a self-inspection by the prospective customer; and
requesting billing information and binding a policy for the property insurance product.

7. The method of claim 1, wherein the additional information about the prospective customer is a loss history.

8. The method of claim 1, wherein the additional information about the prospective customer is an insurance rating.

9. A system for making an insurance evaluation related to property insurance, the system comprising:
one or more data sources storing data relating to insurance coverage and insurance risk;
one or more computer processors in communication with the one or more data sources;
a virtual server in communication with the one or more data sources;
a communications device in communication with the virtual server; and
a memory, in communication with the one or more computer processors, storing program instructions which cause the one or more computer processors to:
provide a platform that is configured to be accessed by a prospective customer over an internet network;
receive a property address of the prospective customer;
request insurance application data from one or more data sources;
receive insurance application data from the one or more data sources;
analyze the insurance application data with underwriting rules implemented by the platform;
determine a risk category for the prospective customer;
generate an initial quote for an insurance product;
receive, from the prospective customer, customized coverage parameters and customized rewards options;
request loss history information and insurance rating information from one or more data sources; and
generate a final quote for the insurance product.

10. The system of claim 9, wherein the property address is a residential property address.

11. The system of claim 9, wherein the risk category is selected from the group consisting of green, yellow, or red.

12. The system of claim 11, further comprising, after the step of determining the risk category, responsive to a determination of a risk category of red, flagging the application as ineligible.

13. The system of claim 11, further comprising:
after the step of generating a final quote, responsive to a determination of a risk category of green, requesting billing information and binding a policy for the property insurance product; and
requesting a self-inspection by the prospective customer.

14. The method of claim 11, further comprising:
after the step of generating a final quote, responsive to a determination of a risk category of yellow, requesting a self-inspection by the prospective customer; and
requesting billing information and binding a policy for the property insurance product.

15. A method of providing one or more bindable insurance quotes to a prospective customer without receiving any personally identifying information from the prospective customer, the method comprising:
providing, by a system having at least one processor and at least one memory, a first graphical user interface configured for entry of a property address;
receiving the property address from the prospective customer;
requesting, from one or more data sources, insurance application information about the property address;
receiving the insurance application information from the one or more data sources;
applying underwriting rules stored on the memory to the insurance data;
determining a risk category;
determining an initial quote based on one or more underwriting rules and risk category;
providing a second graphical user interface configured for customizing insurance coverage parameters and reward options;
determining a finalized quote;
providing a third graphical user interface configured for entry of personal information from the prospective customer; and
generating disclosure schedules for the finalized quote.

16. The method of claim 15, further comprising, after providing a second graphical user interface:
requesting, from one or more data sources, a loss history and an insurance rating for the prospective customer.

17. The method of claim 15, wherein the risk category is selected from the group consisting of green, yellow, and red.

18. The method of claim 17, further comprising, after the step of determining the risk category, responsive to a determination of a risk category of red, flagging the application as ineligible and sending to an offline agent for further processing.

19. The method of claim 17, further comprising:
after the step of generating a final quote, responsive to a determination of a risk category of green, requesting billing information and binding a policy for the property insurance product; and
requesting a self-inspection by the prospective customer.

20. The method of claim 17, further comprising:
after the step of generating a final quote, responsive to a determination of a risk category of yellow, requesting a self-inspection by the prospective customer; and
requesting billing information and binding a policy for the property insurance product.
